(19) United States
(12) Patent Application Publication
(10) Pub. No.: US 2022/0373128 A1
(43) Pub. Date: Nov. 24, 2022

(54) STANDS FOR ELECTRONIC DEVICES

(71) Applicant: HEWLETT-PACKARD DEVELOPMENT COMPANY, L.P., Spring, TX (US)

(72) Inventors: Ilchan LEE, Spring, TX (US); Jin Cherl KWON, Spring, TX (US); Hyunmin MOON, Spring, TX (US)

(21) Appl. No.: 17/328,793

(22) Filed: May 24, 2021

(51) Int. Cl. F16M 11/12; F16M 11/04; G03B 15/02; G03B 17/56

(52) U.S. Cl. CPC F16M 11/12; F16M 11/046; G03B 15/02; G03B 17/561

(57) ABSTRACT

An example stand for an electronic device includes a base, a column extending upward from the base, a camera coupled to the column, and an interface supported on the column that is to engage with the electronic device to suspend the electronic device on the column.

### BACKGROUND

Video conferencing has become an established mode of communication for organizations and individuals. Electronic devices (e.g., smartphones, tablet computers, desktop computers, laptop computers, all-in-one computers) may include systems and applications for conducting a video conference, such as, for instance, a display panel, a camera, a microphone, and a speaker.

### BRIEF DESCRIPTION OF THE DRAWINGS

Various examples will be described below referring to the following figures:

FIG. 1 is a perspective view of a stand for an electronic device for facilitating a video conference according to some examples;

FIGS. 2 and 3 are front views of the stand of FIG. 1 with the interface of the stand rotated to different positions according to some examples;

FIG. 4 is an enlarged, side view of a coupling between a column and interface of the stand of FIG. 1 according to some examples;

FIG. 5 is an enlarged front view of a carriage within the column of the stand of FIG. 1 according to some examples;

FIG. 6 is an enlarged side view of the stand of FIG. 1 coupled to an electronic device according to some examples;

FIG. 7 is a top view of the column of the stand of FIG. 1 according to some examples;

FIG. 8 is a perspective view of the stand of FIG. 1 coupled to an electronic device and with elongate light arrays of the stand in a deployed position according to some examples; and

FIG. 9 is a system diagram of the stand of FIG. 1 and an electronic device coupled thereof according to some examples.

### DETAILED DESCRIPTION

Electronic devices may be used to conduct video conferences. In some instances, the electronic device may be a mobile electronic device that may be readily transported from place to place. Some examples of a mobile electronic device include smartphones and tablet computers. When conducting a video conference with a mobile electronic device, a user may hold the electronic device in place or may attempt to prop up the electronic device on a wall or other structure to align the camera and/or the display panel with the user's face. In addition, depending on where a user is conducting a video conference, the available lighting may be insufficient to adequately light-up the user's face.

Accordingly, the examples disclosed herein include stands for an electronic device (e.g., a mobile electronic device) that may facilitate and enhance video conferencing utilizing the electronic device. In some examples, the example stands may be used to maintain a position of a mobile electronic device during a video conference. In addition, the example stands may include additional features, such as cameras, lights, and/or additional connection ports for enhancing video conferencing with the electronic device. Thus, through use of the example stands, video conferencing via an electronic device (e.g., a mobile electronic device) may be enhanced.

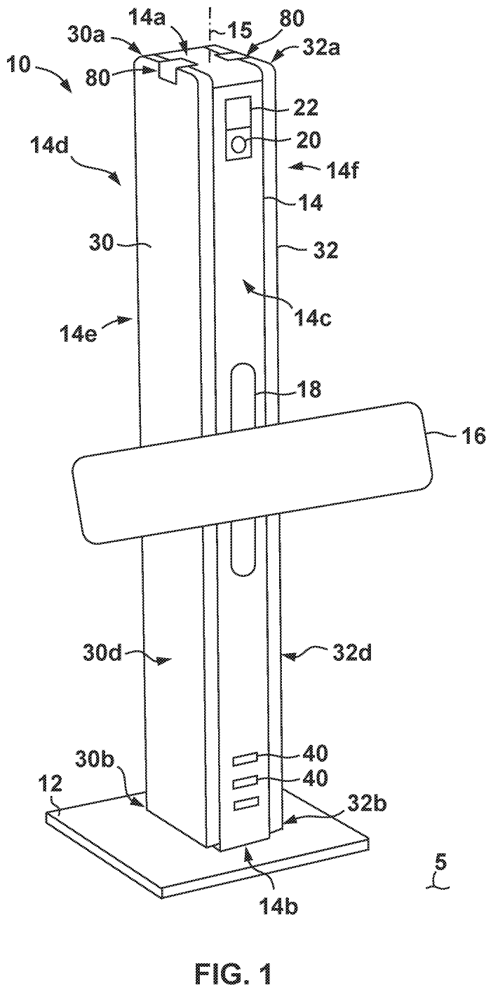

Referring now to FIGS. 1-3, a stand 10 for supporting an electronic device, and more particularly for supporting a mobile electronic device, is shown. The stand 10 includes a base 12 that may engage with a support surface 5 (e.g., the floor, a table, a countertop, a desk).

A column 14 is coupled to and extends upward from base 12. In particular, column 14 includes a central or longitudinal axis 15, a first or upper end 14a, and a second or lower end 14b opposite upper end 14a. The column 14 is coupled to base 12 at lower end 14b, such that upper end 14a is projected away from base 12 along longitudinal axis 15. Column 14 also includes a front side 14c, a rear side 14d opposite front side 14c, and a pair of lateral sides 14e, 14f extending between the front side 14c and rear side 14d. The front side 14c, rear side 14d, and lateral sides 14e, 14f extend axially between lower end 14b and upper end 14a. In addition, the front side 14c opposes the rear side 14d across longitudinal axis 15, and the lateral sides 14e, 14f oppose one another across longitudinal axis 15. During operations, front side 14c may generally face toward the user of the electronic device (not shown).

In some examples, the column 14 may be pivotably coupled to the base 12 such that during operations, the column 14 may rotate or pivot about longitudinal axis 15 relative to base 12. In some examples, the column 14 may be coupled to base 12 via a bearing, or other suitable structure or device (not shown) that may facilitate the relative rotation of column 14 about longitudinal axis 15 relative to base 12.

Stand 10 includes an interface 16 coupled to front side 14c of column 14, between the ends 14a, 14b. As will be described in more detail below, the interface 16 is to engage with an electronic device (e.g., a tablet computer, smartphone) such that the electronic device is suspended on column 14, above the base 12 during operations.

In addition, stand 10 includes a camera 20 mounted to front side 14c of column 14 and axially positioned between interface 16 and upper end 14a with respect to longitudinal axis 15. The camera 20 may include a shutter 22 that may be actuated (e.g., slid, flipped) by a user to cover the camera 20 during operations. The camera 20 may be of a generally higher quality than cameras that are normally installed within an electronic device (e.g., such as the user-facing camera in a smartphone or tablet computer).

A plurality of connection ports 40 are positioned on column 14. In some examples, the connection ports 40 may be positioned on front side 14c, proximate lower end 14b, such as between interface 16 and lower end 14b. However, connection ports 40 may be positioned along rear side 14d and/or the lateral sides 14e, 14f in some examples. In some examples, connection ports 40 may be positioned on base 12. The connection ports 40 may comprise any suitable type for connecting with another device (e.g., an electronic device, a peripheral device such as a mouse, printer, keyboard, etc., an external hard drive, a docking station, a display panel). For instance, in some examples, connection ports 40 may comprise a universal serial bus (USB) port, a high-definition multimedia interface (HDMI) port, a video graphics array (VGA) port, an electrical power port, etc.

Referring still to FIGS. 1-3, a pair of elongate light arrays 30, 32 are pivotably coupled to column 14. As used herein, the term “elongate” refers to an object that has a length longer than its width. In particular, the elongate light arrays 30, 32 are pivotably coupled to upper end 14a of column 14 and may be pivoted between a stowed position shown in FIGS. 1-3 in which the elongate light arrays 30, 32 extend axially along the lateral sides 14e, 14f, respectively, of column 14, and a deployed position shown in FIG. 8 (described in more detail below) in which the elongate light arrays 30, 32 are rotated relative to column 14 so as to extend outward therefrom (e.g., laterally outward). The elongate light arrays 30, 32 are discussed in more detail below.

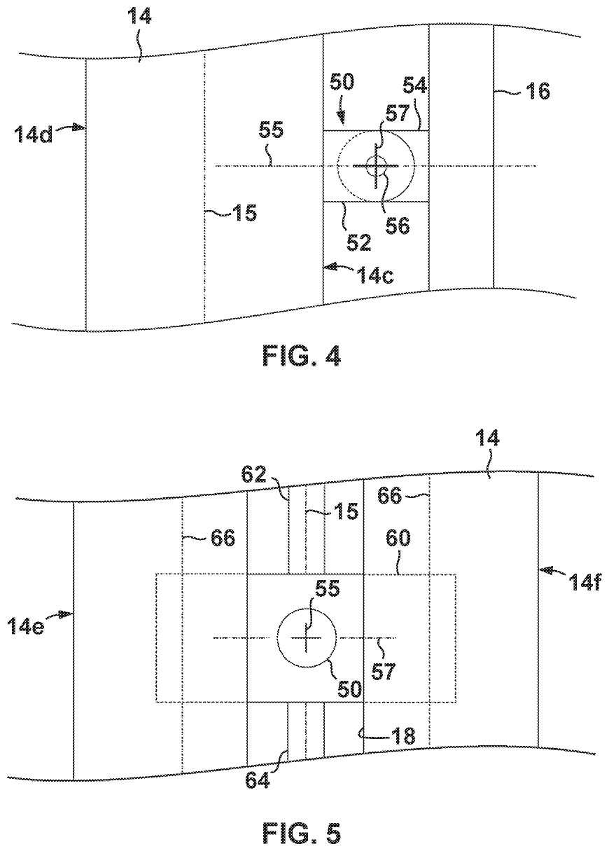

Referring now to FIG. 4, interface 16 is pivotably coupled to front side 14c of column 14 via a pivotable coupling assembly 50. In some examples, the pivotable coupling assembly 50 may include a pinned connection that comprises a first post 52 coupled to front side 14c of column 14 and a second post 54 coupled to interface 16. The first post 52 may be coupled to the second post 54 with a pin 56.

During operations, the pivotable coupling assembly 50 may facilitate pivoting or rotation of the interface 16 relative to the column 14 about a pair of orthogonal axes of rotation 55 and 57. In particular, a tilt of the interface 16 (and thus a tilt of an electronic device coupled to interface 16) may be adjusted by rotating the second post 54 about an axis of rotation 57 relative to the first post 52, via the pin 56. The axis of rotation 57 extends in a direction that is perpendicular to the longitudinal axis 15 of column 14, but the axis of rotation 57 may not intersect with the longitudinal axis 15.

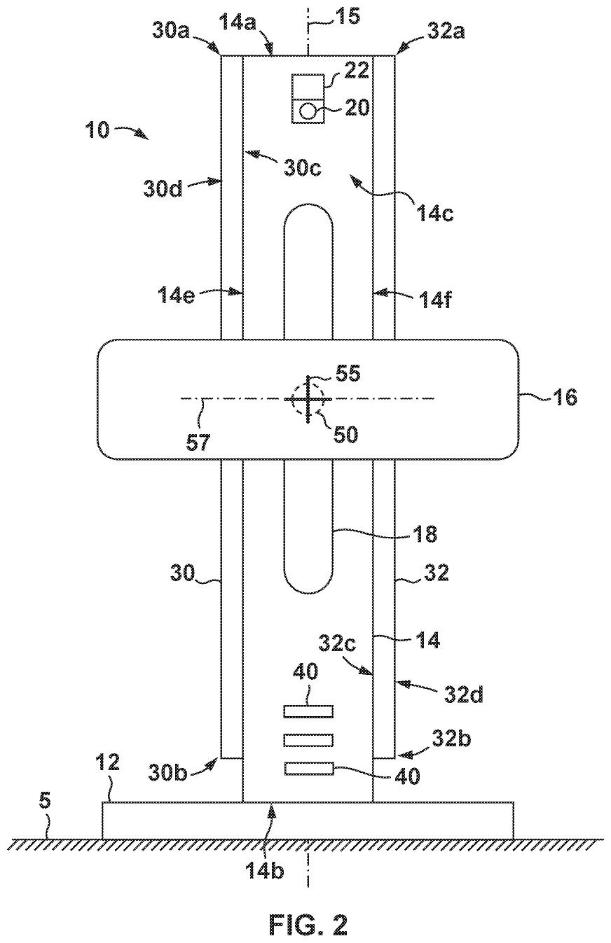

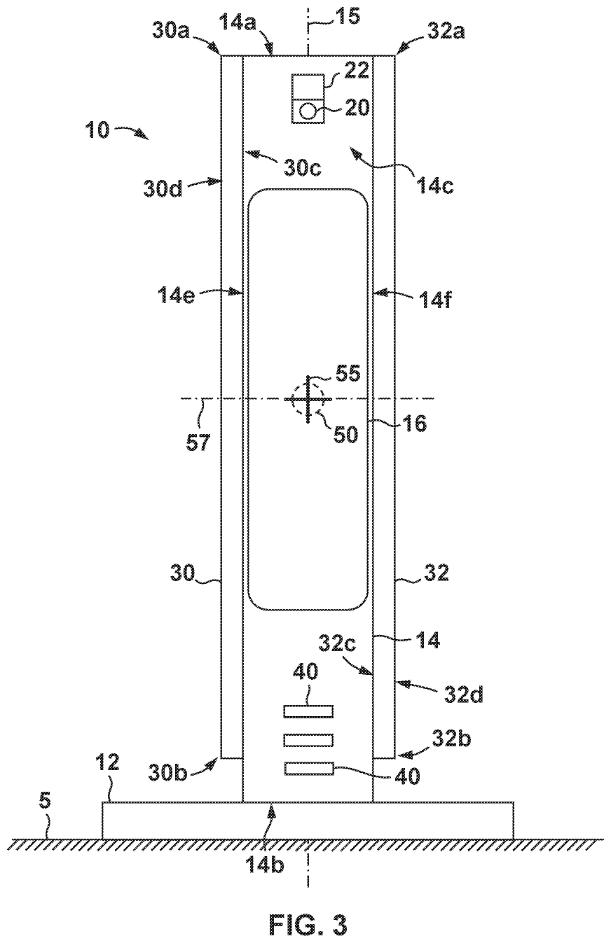

In addition, the interface 16 may be rotated about an axis of rotation 55 that is orthogonal to the axis of rotation 57. The axis of rotation 55 may also be non-parallel to the longitudinal axis 15 of column 14. When the interface 16 is positioned relative to the column 14 as show in FIG. 4 (e.g., with the interface 16 positioned at a zero tilt angle to place a display panel of an attached electronic device in parallel with the longitudinal axis 15), the axis of rotation 55 may be orthogonal to the longitudinal axis 15 (and thus may extend a direction that is perpendicular to the longitudinal axis 15). In particular, in some examples, the second post 54 may be pivotably coupled to interface 16 so that interface 16 may be pivoted relative to second post 54 about axis of rotation 55. In some examples, a bearing or other suitable structure or device (not shown) may be coupled between the second post 54 and interface 16 to facilitate the relative rotation of interface 16 and second post 54. Referring briefly again to FIGS. 2 and 3, during operations, the pivotable coupling assembly 50 may allow interface 16 to be pivoted about axis of rotation 55 to selectively place an electronic device (not shown) coupled to interface 16 in a landscape orientation (FIG. 2) and a portrait orientation (FIG. 3).

Referring again to FIGS. 1 and 2, the interface 16 may also be translated axially along column 14 between the ends 14a, 14b with respect to longitudinal axis 15 to adjust a height of interface 16 (and thus also a height of an electronic device coupled to the interface 16) above base 12 and support surface 5. In particular, the interface 16 may be translated along an axially oriented slot 18 extending into front side 14c of column 14. The slot 18 may be elongated along the longitudinal axis 15 and may define the axial travel range of the interface 16 during operations.

Referring now to FIG. 5, in some examples, the pivotable coupling assembly 50, may be coupled to a carriage 60. In FIG. 5, the interface 16 has been removed and the pivotable coupling assembly 50 is represented schematically (e.g., as a circle) to simplify the drawing and better depict the carriage 60 and associated structures. The carriage 60 may be positioned within the column 14 such that the pivotable coupling assembly 50 (e.g., including the posts 52, 54) couples the interface 16 (FIG. 4) and carriage 60 to one another through the slot 18. The carriage 60 is to slidably mounted to a pair of rails 66 within the column 14 that may allow carriage 60 slide axially along the column 14 with respect to the longitudinal axis 15. In particular, rails 66 may extend axially along slot 18 so as to guide the axial movement of carriage 60 during operations.

A pair of biasing members 62, 64 may be coupled to the carriage 60. During operations, the biasing members 62, 64 may exert balanced forces on the either side of carriage 60 so as to allow carriage 60 to maintain a selected axial position along the column 14 during operations. In some examples, the biasing members 62, 64 may comprise coiled springs and/or piston-cylinder assemblies. In some examples, the biasing members 62, 64 may be omitted and the frictional engagement between the carriage 60 and rails 66 may be sufficient to allow carriage 60 to maintain a selected position along slot 18 during operations. In some examples, a ratchet assembly may be coupled to carriage 60 and/or rails 66 that may maintain the carriage 60 in a selected axial position along slot 18 during operations.

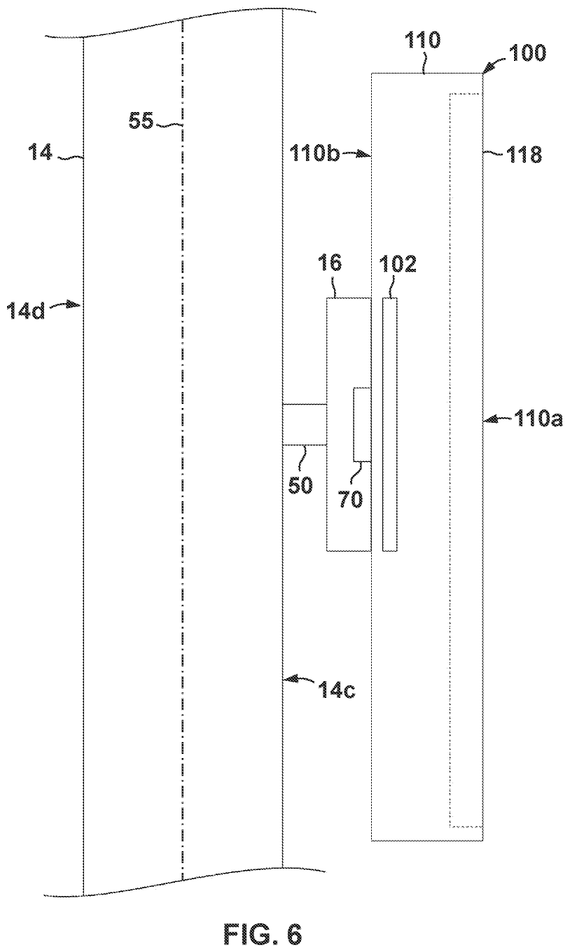

Referring now to FIG. 6, interface 16 may be engaged with and secured to an electronic device 100 via any suitable device or mechanism. For instance, in some examples, the interface 16 may mechanically latch to a suitable connector on a housing 110 of the electronic device 100. In some examples, as shown in FIG. 6, the interface 16 may comprise a magnet (or plurality of magnets) 70 that may magnetically attract a corresponding magnetic material 102 positioned on or within the housing 110 of electronic device 100. The magnet (or magnets) 70 may comprise electromagnets or permanent magnets. In some examples, the electronic device 100 comprises a tablet computer or smartphone, such that the housing 110 has a front side 110a supporting a display panel 118 and a rear side 110b that is opposite the front side 110a. The magnetic material 102 may be positioned on, along, or under the rear side 110b such that when the electronic device 100 is engaged with the interface 16, the display panel 118 may face outward or away from front side 14c of column 14. The magnetic material 102 may comprise any material that may experience a force due to the presence of a magnetic field. In some examples, the magnetic material 102 may comprise a magnet (e.g., permanent magnet, electromagnet) and/or a ferromagnetic material (e.g., iron), etc.

Referring now to FIGS. 1, 7, and 8, the elongate light arrays 30, 32 are pivotably coupled to the upper end 14a of column 14 and positioned on the opposing lateral sides 14e, 14f, respectively. In particular, each elongate light array 30, 32 includes a first or proximal end 30a, 32a, that is pivotably coupled to upper end 14a of column 14, and a second or distal end 30b, 32b that is spaced from proximal end 30a, 32a, respectively. The elongate light arrays 30, 32 may comprise one (or a plurality of) light emitting devices. For instance, in some examples, the elongate light arrays 30, 32 may comprise bar lights including a plurality of light emitting diodes (LEDs). In addition, the elongate light arrays 30, 32 may comprise lenses, reflectors, diffusers, etc. for directing, softening, concentrating, etc. the light that is emitted from the light emitting devices during operations.

The elongate light arrays 30, 32 may include a first side 30c, 32c, respectively, and a second side 30d, 32d opposite first side 30c, 32c, respectively. The sides 30c, 30d may extend in parallel with one another between the ends 30a, 30b, and the sides 32c, 32d may extend in parallel with one another between the ends 32a, 32b. In some examples, the light emitting devices (e.g., LEDs) may be positioned along the first sides 30c, 32c, while the second sides 30d, 32d may comprise an opaque surface (e.g., a polymer surface, metallic surface).

The proximal ends 30a, 32a may be pivotable coupled to upper end 14a of column 14 via pair of pivotable coupling assemblies 80. During operations, the elongate light arrays 30, 32 may be pivoted relative to column 14 via pivotable coupling assembles 80 to a stowed position shown in FIGS. 1-3 and 7 in which the elongate light arrays 30, 32 are extended axially along the lateral sides 14e, 14f, respectively, of the column 14. In the stowed position, the first sides 30c, 32c may face inward, toward longitudinal axis 15 and the second sides 30d, 32d may face outward, away from longitudinal axis 15 along lateral sides 14e, 14f, respectively, of column 14. Thus, in the stowed position, the light emitting devices (e.g., LEDs) positioned on/along first side 30c, 32c may face inward toward the lateral sides 14e, 14f of the column 14.

In addition, during operations, the elongate light arrays 30, 32 may be pivoted relative to the column 14 via pivotable coupling assemblies 80 to a deployed position shown in FIG. 8, in which the elongate light arrays 30, 32 are extended outward (e.g., laterally outward) from the lateral sides 14e, 14f. In the deployed position, the first sides 30c, 32c of elongate light arrays 30, 32, respectively may face a user (not shown) positioned in front of front side 14c of column 14. Accordingly, light emitted from the elongate light arrays 30, 32 (e.g., from light emitting devices positioned on/along first sides 30c, 32c) may be generally directed toward the user (not shown).

Referring still to FIGS. 1, 7, and 8, the pivotable coupling assemblies 80 may allow rotation or pivoting of the elongate light arrays 30, 32 in multiple, orthogonal axes to transition the elongate light arrays 30, 32 between the stowed position (FIG. 1) and the deployed position (FIG. 8). In some examples, the pivotable coupling assemblies 80 may each comprise a first coupling member 82 mounted to column 14 and a second coupling member 84 pivotably coupled to the proximal end 30a, 32a of one of the elongate light arrays 30, 32, respectively. The second coupling members 84 may be coupled (e.g., pinned) to the proximal ends 30a, 32a of elongate light arrays 30, 32 such that the elongate light arrays 30, 32 may pivot about axes 87 to rotate the distal ends 30b, 32b, respectively, toward and away from the lateral sides 14e, 14f, respectively, of column 14 during operations. In addition, the second coupling members 84 are pivotably coupled to first coupling members 82 within each pivotable coupling assembly 80 such that the second coupling members 84, and the elongate light arrays 30, 32 coupled thereto, may pivot about axes 85. Within each pivotable coupling assembly 80, the axis 85 is orthogonal to the axis 87. In addition, for each pivotable coupling assembly 80, the axes 85, 87 may define a plane that is perpendicular to the longitudinal axis 15 of column 14.

During operations, when transitioning the elongate light arrays 30, 32 from the stowed position (FIG. 1) to the deployed position (FIG. 8), the elongate light arrays 30, 32 may first be pivoted about axes 87 via the pivotably coupling between the elongate light arrays 30, 32 and the second coupling members 84. Next, the elongate light arrays 30, 32 may be pivoted about axes 85 to face or point the light emitting devices (e.g., LEDs) of the elongate light arrays 30, 32 toward the user (not shown) positioned in front of front side 14c of column 14. Likewise, transitioning the elongate light arrays 30, 32 from the deployed position (FIG. 8) to the stowed position (FIG. 1) may also be accomplished by rotating the elongate light arrays 30, 32 about axes 85, 87 via the pivotable coupling assemblies 80.

In some examples, the elongate light arrays 30, 32 may be activated by transitioning the elongate light arrays 30, 32 from the stowed position (FIG. 1) to the deployed position (FIG. 8). In some examples switches may be coupled to the pivotable coupling assemblies 80 such that rotation about the axis 85, and/or the axis 87 may actuate a switch to activate/deactivate the light emitting devices (e.g., LEDs) of the elongate light arrays 30, 32. In some examples, the elongate light arrays 30, 32 may be activated via a user interface device (e.g., button, touch sensitive surface, switch) positioned on the stand 10 (e.g., on column 14, base 12), and/or by a command emitted from the electronic device 100 (e.g., when the electronic device 100 is engaged with interface 16).

Referring now to FIGS. 1 and 8, during operations, when a user desires to conduct a video conference with the electronic device 100, the user may engage the electronic device 100 with the interface 16 so as to suspend the electronic device 100 from column 14 as previously described. The user may position the electronic device 100 in a desired orientation and position on column 14 via movement of the interface 16 axially between ends 14a, 14b, and rotating the interface 16 relative to column 14 as previously described (FIGS. 2 and 3).

In addition, while conducting the video conference using electronic device 100 supported on stand 10, the user may activate camera 20 to capture images of the user so that others participating in the video conference may see the user. As previously described, the camera 20 may be of higher quality than a user-facing camera (not shown) within the electronic device 100 so that the user's video feed and/or images may be enhanced (e.g., clearer, sharper, smoother).

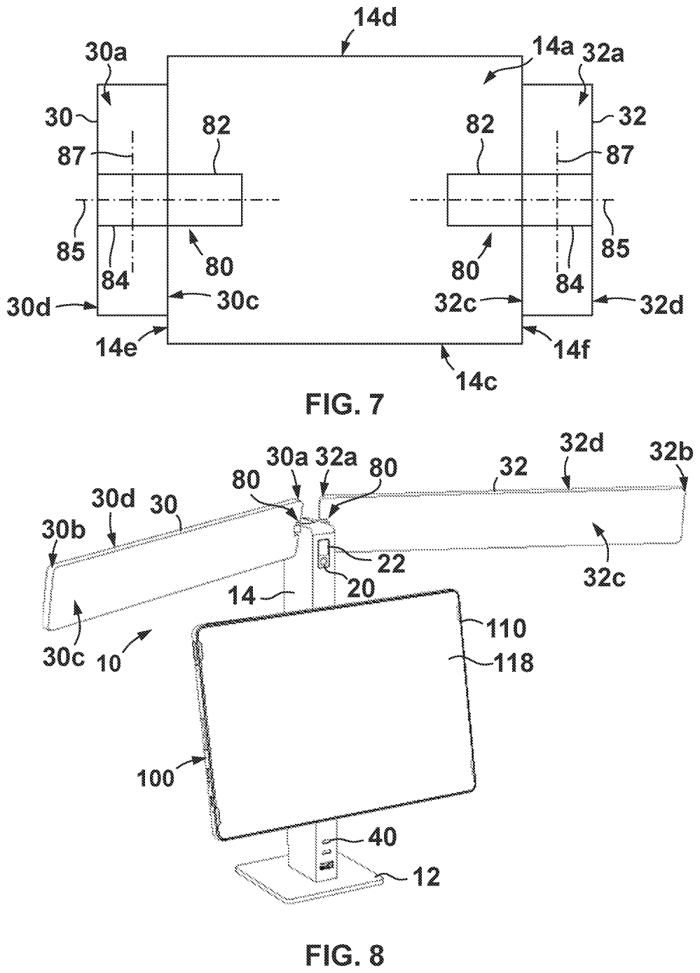

Further, while conducting the video conference using electronic device 100 supported on stand 10, the user may activate the elongate light arrays 30, 32 to light-up the user so that the user is clearly visible in the images/video captured by the camera 20. In particular, the user may transition the elongate light arrays 30, 32 from the stowed position (FIG. 1) to the deployed position (FIG. 8) by rotating the arrays about the orthogonal axes (axes 85, 87 shown in FIG. 7) of the pivotable coupling assemblies 80 as previously described.

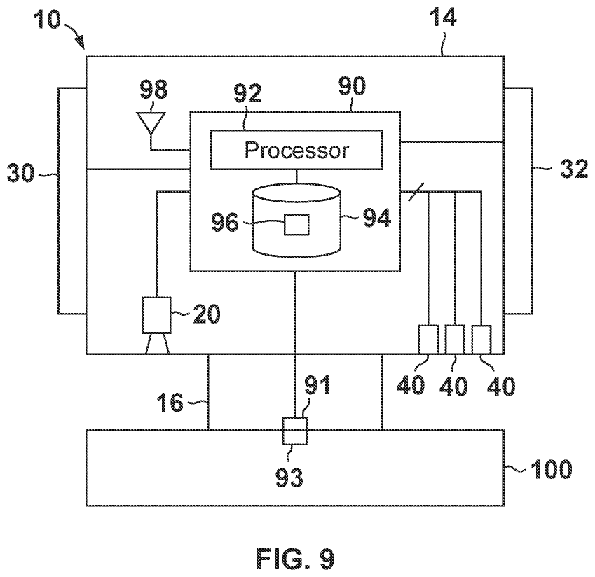

Referring now to FIG. 9, in some examples, stand 10 may include a controller 90 that is to control various functionalities and components of stand 10 during operations. Controller 90 may include a processor 92 and a memory 94.

The processor 92 may comprise any suitable processing device, such as a microcontroller, central processing unit (CPU), graphics processing unit (GPU), timing controller (TCON), scaler unit. The processor 92 executes machine-readable instructions (e.g., machine-readable instructions 96) stored on memory 94, thereby causing the processor 92 to perform some or all of the actions attributed herein to the processor 92. In general, processor 92 fetches, decodes, and executes instructions (e.g., machine-readable instructions 96). In addition, processor 92 may also perform other actions, such as, making determinations, detecting conditions or values, etc., and communicating signals. If processor 92 assists another component in performing a function, then processor 92 may be said to cause the component to perform the function.

The memory 94 may comprise volatile storage (e.g., random access memory (RAM)), non-volatile storage (e.g., flash storage, etc.), or combinations of both volatile and non-volatile storage. Data read or written by the processor 92 when executing machine-readable instructions 96 can also be stored on memory 94. Memory 94 may comprise “non-transitory machine readable medium,” where the term “non-transitory” does not encompass transitory propagating signals.

The processor 92 may comprise one processing device or a plurality of processing devices that are distributed within stand 10. Likewise, the memory 94 may comprise one memory device or a plurality of memory devices that are distributed within the stand 10.

The controller 90 may be coupled to the electronic device 100 when the electronic device 100 is engaged with the interface 16. In some examples, controller 90 may be communicatively coupled to electronic device 100 via a wireless connection through an antenna 98. The wireless connection established via antenna 98 may comprise any suitable wireless communication technique or protocol (e.g., WIFI, radiofrequency communication, BLUETOOTH®, nearfield communication, infrared communication). In some examples, the wireless connection between controller 90 and electronic device 100 (e.g., via antenna 98) may be established upon engaging the electronic device 100 with interface 16. For instance, a magnetic sensor (e.g., Hall-effect sensor) may be coupled to interface 16 that may be used by controller 90 to determine when electronic device 100 is engaged with interface 16 so that a connection routine to establish a wireless connection via antenna 98 may be initiated.

In some examples, controller 90 may be communicatively coupled to the electronic device 100 via a wired connection. For instance, in some examples connectors 91 and 93 on the interface 16 and electronic device 100, respectively, may engage one another when the electronic device 100 is engaged with interface 16 to enable communications therebetween.

Regardless as to whether the communications between electronic device 100 and controller 90 are accomplished via a wireless and/or wired connection, during operations, when electronic device 100 is engaged with interface 16, the electronic device 100 may be communicatively coupled to various components of stand 10 (e.g., elongate light arrays 30, 32, camera 20, connection ports 40), such that power and/or information signals may be routed therebetween. For instance, when the electronic device 100 is engaged with the stand 10, the data (e.g., images) captured by camera 20 may be communicated to electronic device 100, and commands (e.g., settings changes, activation, deactivation) may be issued from the electronic device 100 to the camera 20. In some examples, other devices (e.g., keyboard, mouse, printer) that are coupled to the connection ports 40 may communicate with electronic device 100 via controller 90. In some examples, the commands for activating, deactivating, adjusting, etc. the elongate light arrays 30, 32 may be routed to controller 90 via the electronic device 100. In some examples, the stand 10 may include user interface devices (e.g., buttons, touch sensitive surfaces, switches) that a user may manipulate to change settings, deactivate, activate, etc. the elongate light arrays 30, 32, camera 20, connection ports 40, etc.

Further, in some examples, the stand 10 may be coupled to a source of power (e.g., a wall plug) to provide electrical power for operating the various components thereof (e.g., camera 20, elongate light arrays 30, 32, connection ports 40, controller 90, antenna 98). In some examples, when electronic device 100 is coupled to the interface 16, electrical power may be routed through the stand 10 (e.g., via controller 90) to electronic device 100 to charge a battery of other power source thereof.

The examples disclosed herein include stands for an electronic device (e.g., a mobile electronic device) that may facilitate and enhance video conferencing utilizing the electronic device. As previously described, in some examples, the example stands may be used to maintain a position of a mobile electronic device during a video conference. In addition, the example stands may include additional features, such as cameras, lights, and/or additional connection ports for enhancing video conferencing with the electronic device. Thus, through use of the example stands, video conferencing via an electronic device (e.g., a mobile electronic device) may be enhanced.

In the figures, certain features and components disclosed herein may be shown exaggerated in scale or in somewhat schematic form, and some details of certain elements may not be shown in the interest of clarity and conciseness. In some of the figures, in order to improve clarity and conciseness, a component or an aspect of a component may be omitted.

In the discussion above and in the claims, the terms “including” and “comprising” are used in an open-ended fashion, and thus should be interpreted to mean “including, but not limited to . . . .” Also, the term “couple” or “couples” is intended to be broad enough to encompass both indirect and direct connections. Thus, if a first device couples to a second device, that connection may be through a direct connection or through an indirect connection via other devices, components, and connections. In addition, as used herein, the terms “axial” and “axially” generally refer to positions along or parallel to a central or longitudinal axis (e.g., central axis of a body or a port), while the terms “lateral” and “laterally” generally refer to positions located or spaced to the side of the central or longitudinal axis.

As used herein, including in the claims, the word “or” is used in an inclusive manner. For example, “A or B” means any of the following: “A” alone, “B” alone, or both “A” and “B.” In addition, when used herein including the claims, the word “generally” or “substantially” means within a range of plus or minus 10% of the stated value.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. A stand for an electronic device, the stand comprising:
a base;
a column extending upward from the base;
a camera coupled to the column; and
an interface supported on the column to engage with the electronic device to suspend the electronic device on the column.

2. The stand of claim 1, wherein the column comprises a lower end and an upper end, wherein the lower end is coupled to the base, and wherein the camera is positioned between the interface and the upper end.

3. The stand of claim 1, wherein the camera is to be communicatively coupled to the electronic device when the electronic device is coupled to the interface.

4. The stand of claim 1, wherein the column has a longitudinal axis, and wherein the interface is to pivot about an axis of rotation that extends in a direction that is perpendicular to the longitudinal axis.

5. The stand of claim 1, wherein the interface comprises a magnet that is to attract a magnetic material within the electronic device.

6. The stand of claim 1, comprising a light coupled to the column.

7. The stand of claim 6, wherein the light is pivotably coupled to the column such that the light may be rotated about a pair of orthogonal axes relative to the column.

8. A stand for an electronic device, the stand comprising:
a base;
an interface coupled to the base to engage with the electronic device to suspend the electronic device above the base; and
an elongate light array coupled to the base to pivot about a pair of orthogonal axes.

9. The stand of claim 8, comprising a column having a lower end and an upper end opposite the lower end, wherein the lower end is coupled to the base.

10. The stand of claim 9, comprising a second elongate light array coupled to the upper end of the column, wherein the second elongate light array is to pivot about a second pair of orthogonal axes, and wherein the elongate light array and the second elongate light array are pivotably coupled to opposing sides of the column.

11. The stand of claim 10, wherein the elongate light array and the second elongate light array are pivotable to extend along the opposing sides of the column.

12. The stand of claim 10, wherein the column is to pivot about a longitudinal axis extending between the lower end and the upper end.

13. The stand of claim 12, wherein the column comprises a connection port on the column that is to be communicatively coupled to the electronic device when the electronic device is engaged with the connection port.

14. A stand for an electronic device, that stand comprising:
a column having a lower end and an upper end;
an interface coupled to the column to engage with the electronic device to suspend the electronic device on the column;
a camera coupled to the column that is to be communicatively coupled to the electronic device when the electronic device is engaged with the interface; and
an elongate light array pivotably coupled to the upper end of the column.

15. The stand of claim 14, wherein the interface is positioned between the lower end and the upper end, and wherein the camera is positioned between the interface and the upper end.

16. The stand of claim 15, wherein the column comprises a longitudinal axis extending between the lower end and the upper end, and wherein the interface is to pivot about an axis of rotation that extends in a direction that is perpendicular to the longitudinal axis of the column.

17. The stand of claim 16, wherein the interface is to translate along the column, between the lower end and the upper end.

18. The stand of claim 17, wherein the interface is to pivot about a second axis of rotation that is orthogonal to the axis of rotation.

19. The stand of claim 18, comprising a base that is coupled to the lower end of the column, wherein the column is to pivot about the longitudinal axis relative to the base.

20. The stand of 19, wherein the column comprises a connection port positioned between the interface and the lower end, wherein the connection port is to be communicatively coupled to the electronic device when the electronic device is engaged with the interface.
